(19) United States
(12) Patent Application Publication
(10) Pub. No.: US 2008/0100089 A1
(43) Pub. Date: May 1, 2008

(54) Storage system for a sport utility hardtop and other vehicle accessories

(76) Inventors: Christopher R. Schumacher, Frederick, CO (US); Ronald S. Dahms, Westminster, CO (US)

Correspondence Address: DORR, CARSON & BIRNEY, P.C.;ONE CHERRY CENTER, 501 SOUTH CHERRY STREET, SUITE 800, DENVER, CO, 80246, US

(21) Appl. No.: 11/590,274

(22) Filed: Oct. 30, 2006

(51) Int. Cl. B60J 7/00

(52) U.S. Cl. 296/107.17

(57) ABSTRACT

A storage system for sport utility hardtops and other vehicle parts including accessories. The system includes a storage cart that can be secured to the rear portion of the hardtop while the hardtop is still positioned atop the vehicle body. The hardtop and secured cart can then be lifted off the vehicle body as a unit and the cart placed on a garage floor or other horizontal surface. The stored hardtop is essentially upright on the cart and takes up a minimum of floor space. The cart preferably has rollers and the upright hardtop and cart can be easily and quickly moved across the floor to any convenient storage area and enclosed in a protective cover. The storage system also includes a caddy for the other vehicle parts including accessories. The caddy is designed to mate with the cart and the hardtop stored on it.

### BACKGROUND OF THE INVENTION

1. Field of the Invention

This invention relates to the field of storage arrangements for removable hardtops and other accessories for sport utility vehicles.

2. Discussion of the Background

Sport utility vehicles commonly have removable hardtops so the driver can enjoy an open air experience. In such vehicles, the hardtop is removably attached to the body of the vehicle and once removed, it can simply be stored on the ground or other surface. However, it is very often rested up against a garage or other wall. Although the top in this position takes up less floor space, it can be easily damaged should it slip and fall. Further, even if it remains upright, rub marks and other damage may result. In particular and with tops that have rear windows that are freely hinged, the rear window may flop or drop down and can be damaged as it strikes or is dragged over the garage floor or other surface. If the floor or surface is concrete, this can be a particular problem.

In some prior art storage systems, carts are provided to support the removed hardtop in an upright orientation. However, these storage carts are typically only frames that rest on the floor or other horizontal surface and the top is removed from the vehicle and placed on them. In most cases, the hardtop is relatively heavy (e.g., 100 pounds) and awkward to handle. Consequently, it is often very difficult and time consuming to physically lift the top, manipulate it over the cart, lower it onto the cart, and then secure it in place. Such carts are normally fairly lightweight (e.g., 15 pounds) and are easily moved or tilted as the much heavier top is placed on it. The top must also generally be carefully aligned and placed in a balanced manner on the cart and thereafter held in an upright position by gravity or some securing members. Storage carts with rollers can make this process even more difficult.

With these and other problems in mind, the present invention was developed. In it, the storage cart is first secured to the hardtop while the top is still on the vehicle body. Thereafter, the top and the cart secured to it are manipulated as a unit off of the vehicle body and the cart place on the floor or other horizontal surface. The top is then in an upright, stored position. A mating caddy is also disclosed to hold other vehicle accessories. The caddy mates with the cart and the secured hardtop on it in a compact fashion. The mated caddy and cart can also be covered with a common, protective cover.

### SUMMARY OF THE INVENTION

This invention involves a storage system for sport utility hardtops and other vehicle accessories. The system includes a storage cart that can be secured to the rear portion of the hardtop while the hardtop is still positioned atop the vehicle body. The hardtop and secured cart can then be lifted off the vehicle body as a unit and the cart placed on a garage floor or other horizontal surface. The stored hardtop is essentially upright on the cart and takes up a minimum of floor space. The cart preferably has rollers and the upright hardtop and cart can be easily and quickly moved across the floor to any convenient storage area. A protective cover is also provided to enclose the stored hardtop on the cart.

The storage system of the present invention additionally includes a caddy for other vehicle accessories. The caddy is designed to mate with the cart and the hardtop stored on it. In this manner, the hardtop and other vehicle accessories on the cart and caddy can be conveniently and compactly stored together.

The system is adaptable to both one-piece and two-piece hardtops. In both configurations, the loaded cart and caddy can mate or nest to take up as little space as possible. A protective cover is also provided to enclose the mating and loaded cart and caddy.

### BRIEF DESCRIPTION OF THE DRAWINGS

FIG. 1 is a side view of a sport utility vehicle with a removable hardtop.

FIG. 2 is a perspective view of the hardtop of FIG. 1 removed from the vehicle.

FIG. 3 is a side view of the removed hardtop of FIG. 2 supported in a position resting against a wall.

FIG. 4 is a perspective view of the hardtop storage cart of the present invention.

FIG. 5 is a perspective view of the storage cart of FIG. 4 secured to the rear portion of the hardtop with the hardtop detached from the vehicle body but still resting atop it.

FIGS. 5a-5c are enlarged views of areas of FIG. 5 showing further details of the storage cart as secured to the hardtop.

FIG. 6 is a cross-sectional view taken along line 6-6 of FIG. 5.

FIG. 7 is a perspective view of the hardtop supported in an upright position on the storage cart with the axis of the hardtop extending substantially vertically.

FIG. 8 is a side view taken along line 8-8 of FIG. 7.

FIG. 9 is a cross-sectional view taken along line 9-9 of FIG. 7.

FIGS. 10 and 11 illustrate the manner in which the hardtop in its stored position of FIG. 7 can be easily and quickly enclosed in a protective cover.

FIG. 12 is a side view of a sport utility vehicle with a two-piece hardtop.

FIG. 13 is a perspective view of the vehicle of FIG. 12 with the front portion of the hardtop removed and the storage cart of the present invention secured to the rear portion of the hardtop.

FIG. 14 is a cross-sectional view taken along line 14-14 of FIG. 13.

FIG. 15 is a view of the rear portion of the hardtop removed and supported on the storage cart with the axis of the rear portion extending substantially vertically and with a protective cover enclosing the stored rear portion.

FIG. 16 is a perspective view of a caddy for organizing and storing other vehicle accessories.

FIG. 17 illustrates the caddy with a variety of vehicle accessories positioned between its vertical dividers.

FIGS. 18-19 show the storage cart and caddy of the present invention (FIG. 18) and how they can be mated or nested in a compact fashion (FIG. 19).

FIG. 20 is a perspective view of the mating cart and caddy with the caddy shown empty for clarity.

FIG. 21 is a cross-sectional view taken along line 21-21 of FIG. 20 showing the mating cart and caddy loaded with the stored hardtop and other vehicle accessories.

FIG. 22 illustrates the protective cover that can be used to enclose the mating cart and caddy.

### DETAILED DESCRIPTION OF THE INVENTION

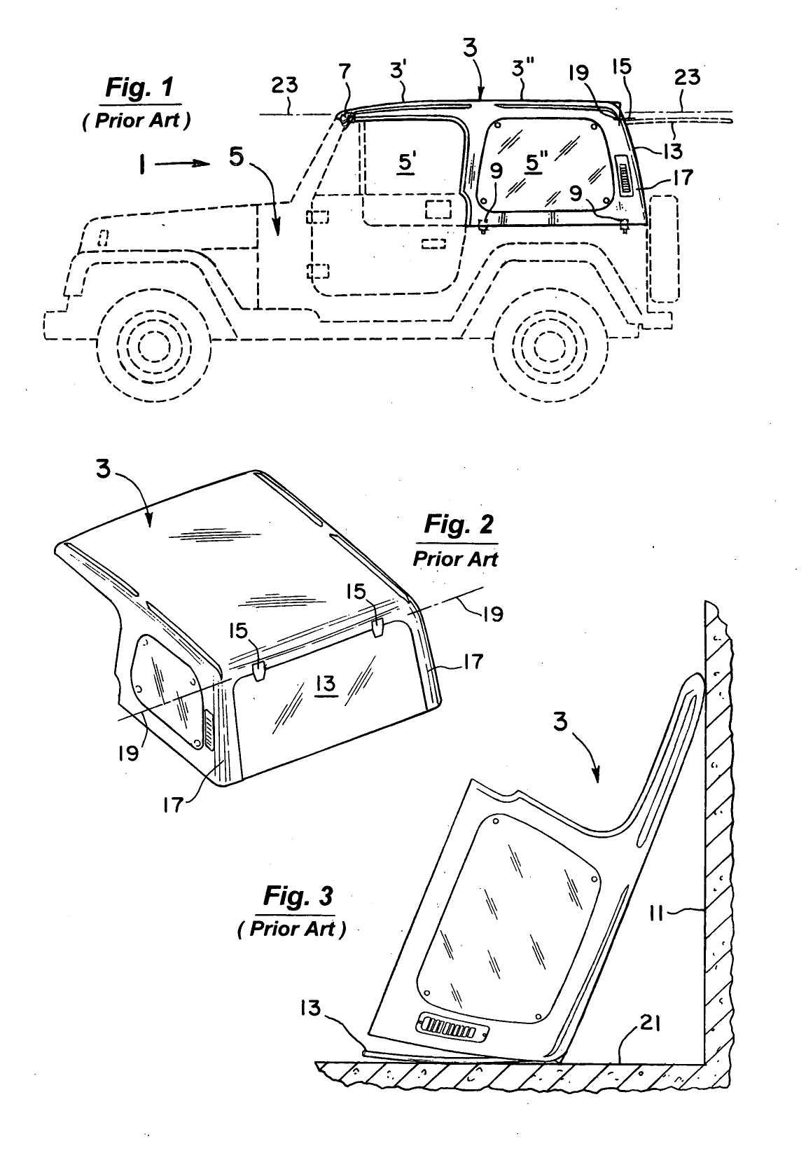

As shown in FIGS. 1-3, sport utility vehicles such as 1 commonly have hardtops such as 3 that are removably attachable to the vehicle body 5. In use, the hardtop 3 can be attached by any number of arrangements to the vehicle body 5 as for example by header clamps such as 7 and bolts such as 9 in FIG. 1. When it is desired to remove the hardtop 3, the attaching members 7,9 are released and the hardtop removed (FIG. 2). The driver is then free to enjoy an open air experience with his or her vehicle; however, storing the often heavy (e.g., 100 pounds) and awkward to handle hardtop 3 can become a problem.

The hardtop 3 can be simply placed on the ground or garage floor in the orientation of FIG. 2 but it is very often rested up against a garage or other wall 11 as in FIG. 3. This takes up less floor space but can result in damage to the hardtop 3 should it slip from the position of FIG. 3. Even in the position of FIG. 3, rub marks and other damage can result. In particular and with many hardtops such as 3, the rear window 13 is often freely hinged at 15 in FIGS. 1 and 2 to the frame 17 of the hardtop 3. The window 13 can then be moved about the pivotal axis 19 between open and closed positions as in FIG. 1. However, in many stored positions including the one of FIG. 3, the window 13 may flop open as in FIG. 3 and can be damaged as it strikes or is dragged over the floor 21. This can be a particular problem if the floor 21 is concrete or another rough surface.

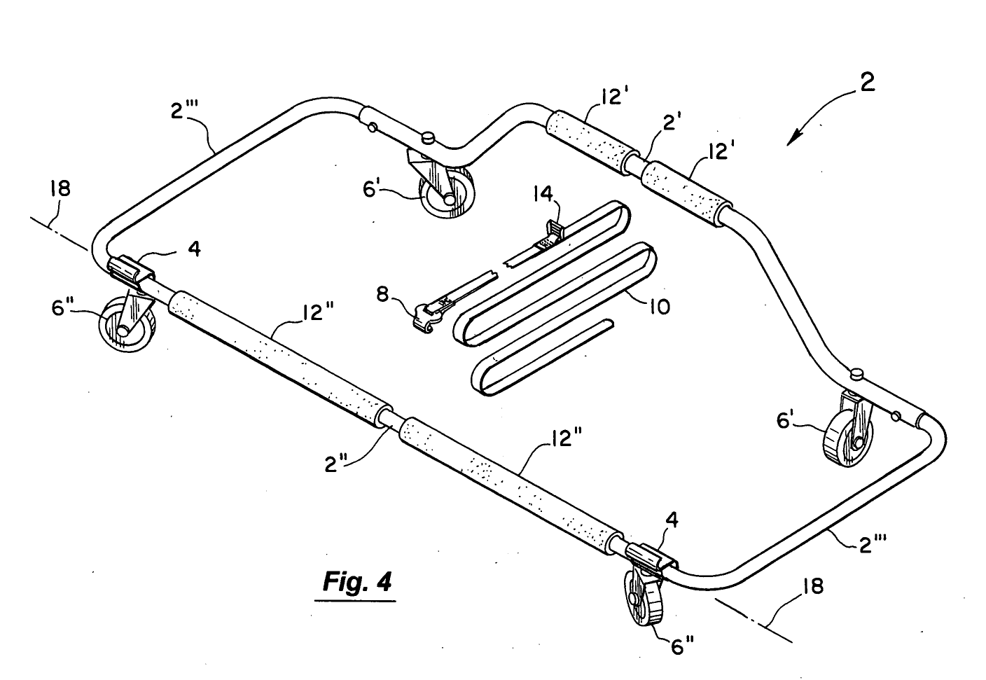

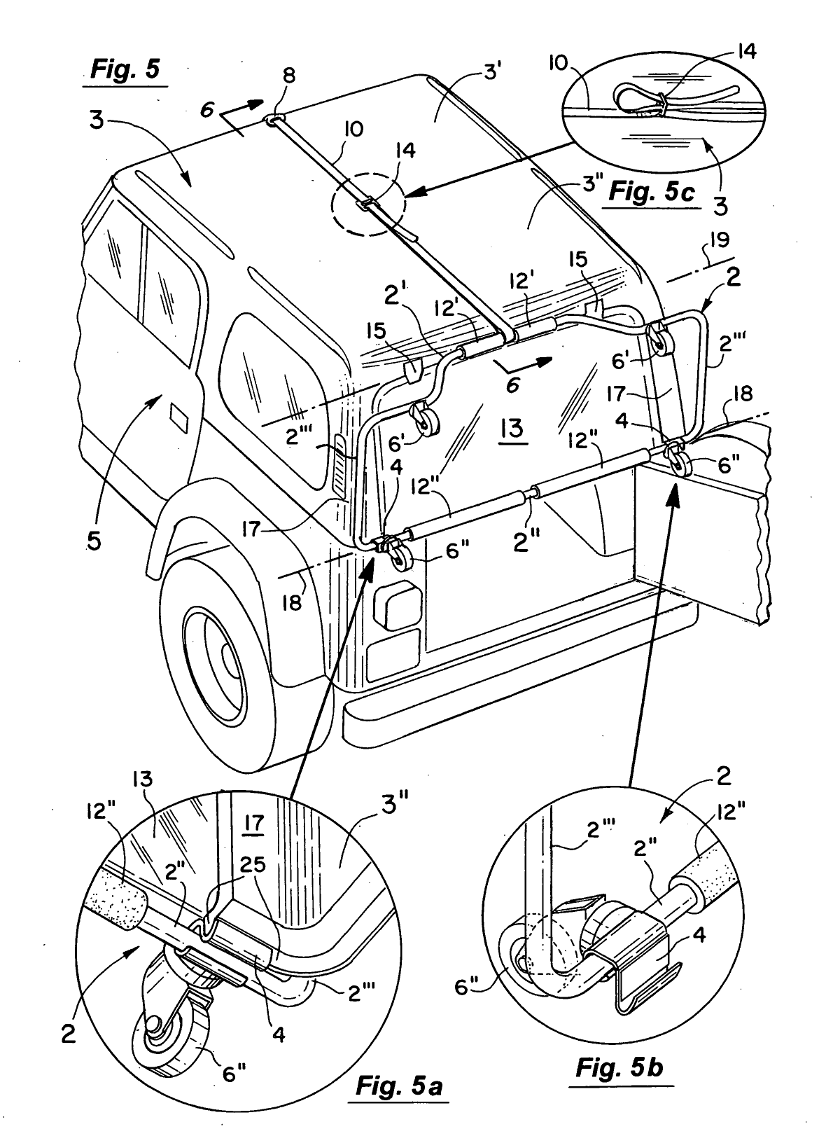

To overcome these and other problems in removing and storing hardtops such as 3 in FIGS. 1-3, the storage system of the present invention was developed. With it, the removable hardtop 3 can be easily and quickly taken off the vehicle body 5 and conveniently and neatly stored. To do so, the hardtop 3 of FIG. 1 is first detached from the vehicle body 5 by releasing the attaching members 7, 9 of FIG. 1. At this point, the hardtop 3 is detached from the vehicle body 5 but still positioned as shown in FIG. 1 with the front portion 3′ of the hardtop 3 covering a forward (e.g., passenger) section 5′ of the vehicle body 5 and the rear portion 3″ covering a rearward (e.g., deck) section 5″ of the vehicle 5. The storage cart 2 of FIG. 4 of the present invention is then secured to the rear portion 3″ of the hardtop 3 as in FIG. 5. The storage car 2 in this regard is relatively lightweight (e.g., 15 pounds) and is very easy to handle and secure to the hardtop 3.

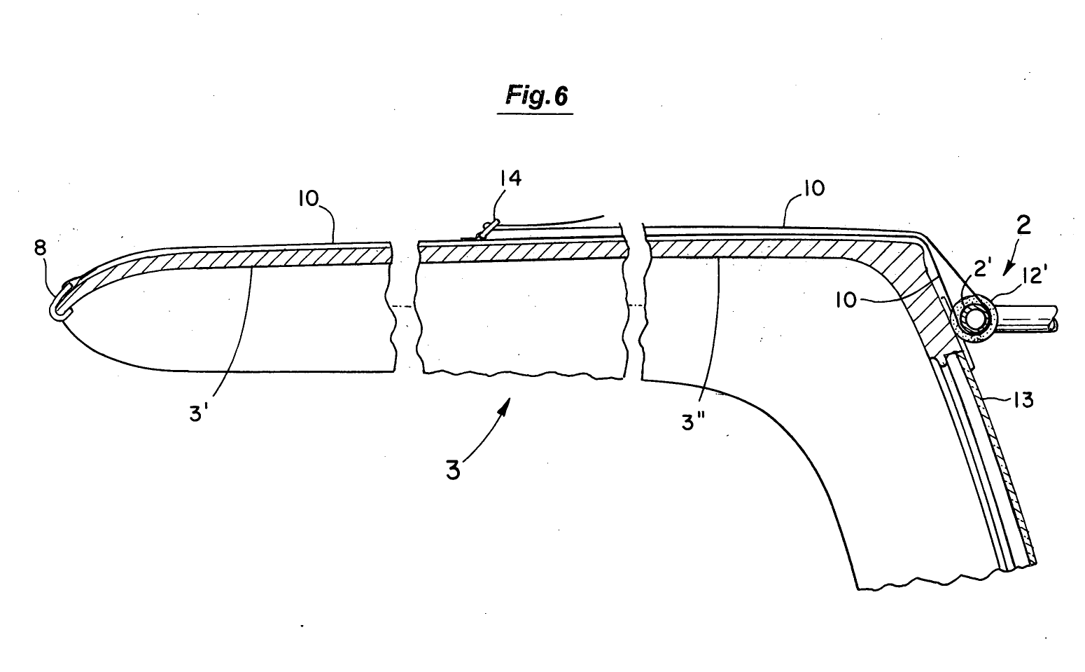

In doing so and with the hardtop 3 detached from the vehicle body 5 but still remaining in the covering position of FIG. 5, the clips 4 adjacent the cart rollers 6″ (FIG. 5a) are hooked over the lower edge or lip 25 of the rear portion 3″ of the hardtop 3 (see also FIG. 5b). Separately, the clip 8 (FIG. 5) is hooked at a location over the forward edge of the front portion 3′ of the hardtop 3. The flexible strap 10 attached to the clip 8 as shown then runs rearwardly (FIGS. 6) down about the bar member 2′ of the cart 2 between the pads 12′ and back along the hardtop 3 through the buckle 14. The adjustable length strap 10 is thereafter drawn taut as in FIG. 5 to secure the cart 2 to the rear portion 3″ of the hardtop 3 in a fixed position.

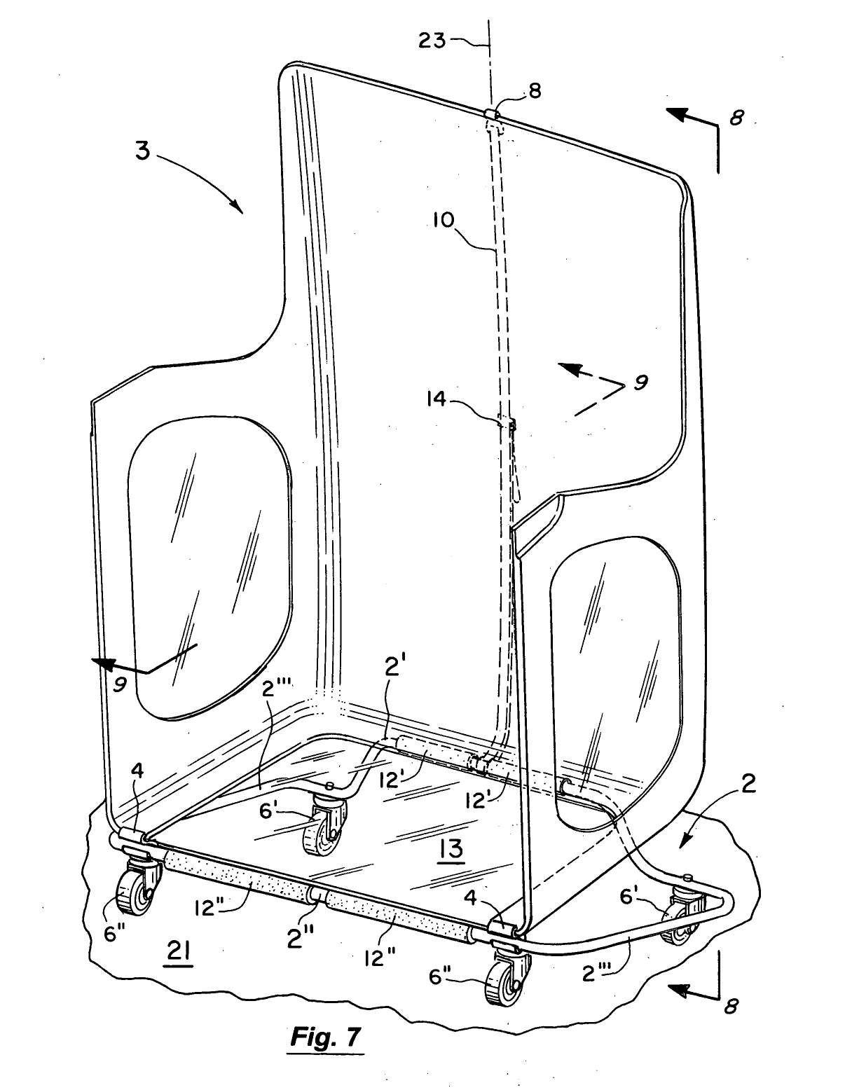

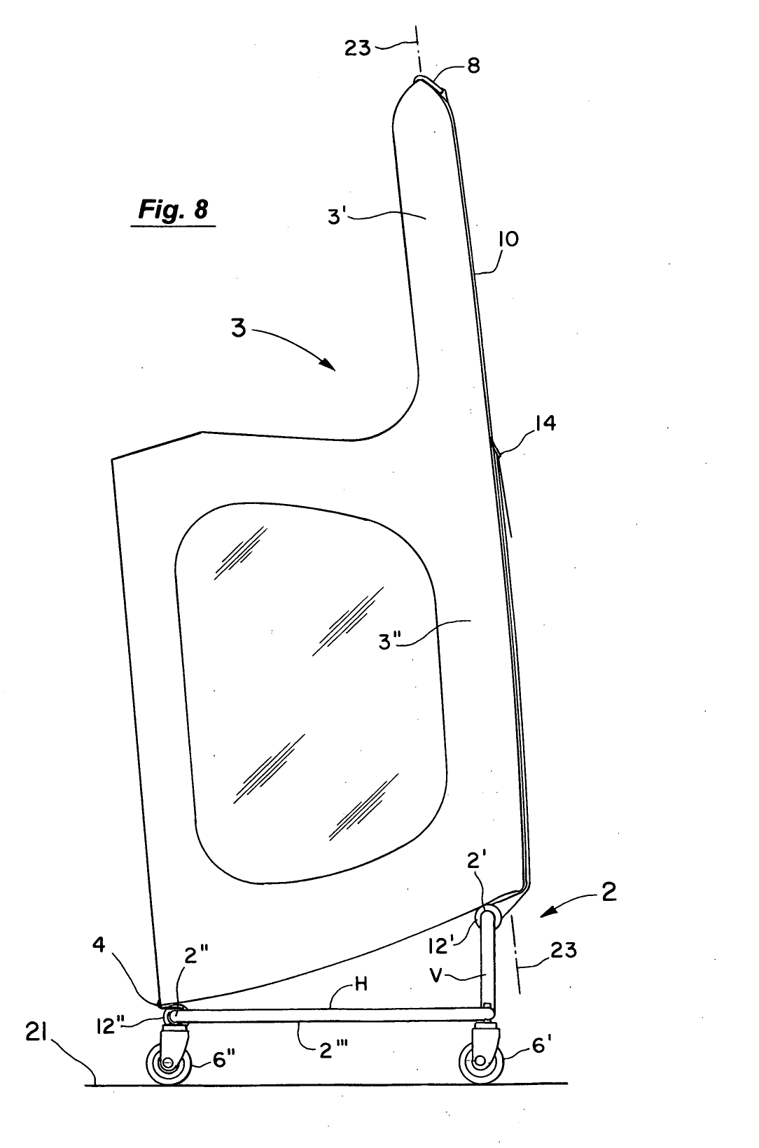

The hardtop 3 can then be lifted off the vehicle body 5 with the storage cart 2 secured thereto and the rollers 6′,6″ of the storage cart 2 placed on a substantially horizontal surface such as the floor 21 in FIG. 7. The front and rear portions 3′,3″ of the hardtop 3 in this regard were originally extending adjacent one another (see FIG. 1) along the axis 23 aligned substantially horizontally atop the vehicle body 5. In the stored orientation of FIG. 7 and 8, the front and rear portions 3′, 3″ then have the axis 23 extending substantially vertically. In the orientation of FIGS. 7 and 8, the storage cart 2 and attached hardtop 3 can be easily and quickly rolled to any desired location in the garage or other area and the rollers 6′,6″ locked in place. The upright hardtop 3 in this position takes up a minimum of floor space and is securely held in place on the storage cart 2 by the clips 4,8 and tightened strap 10.

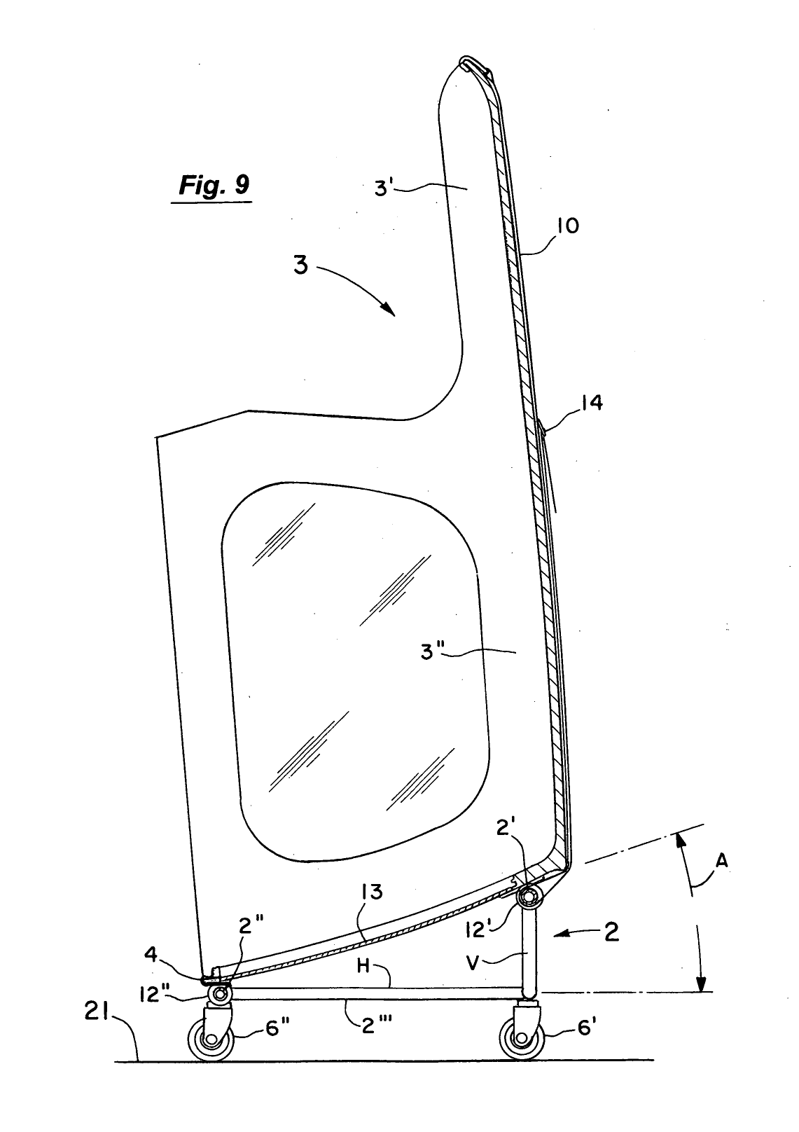

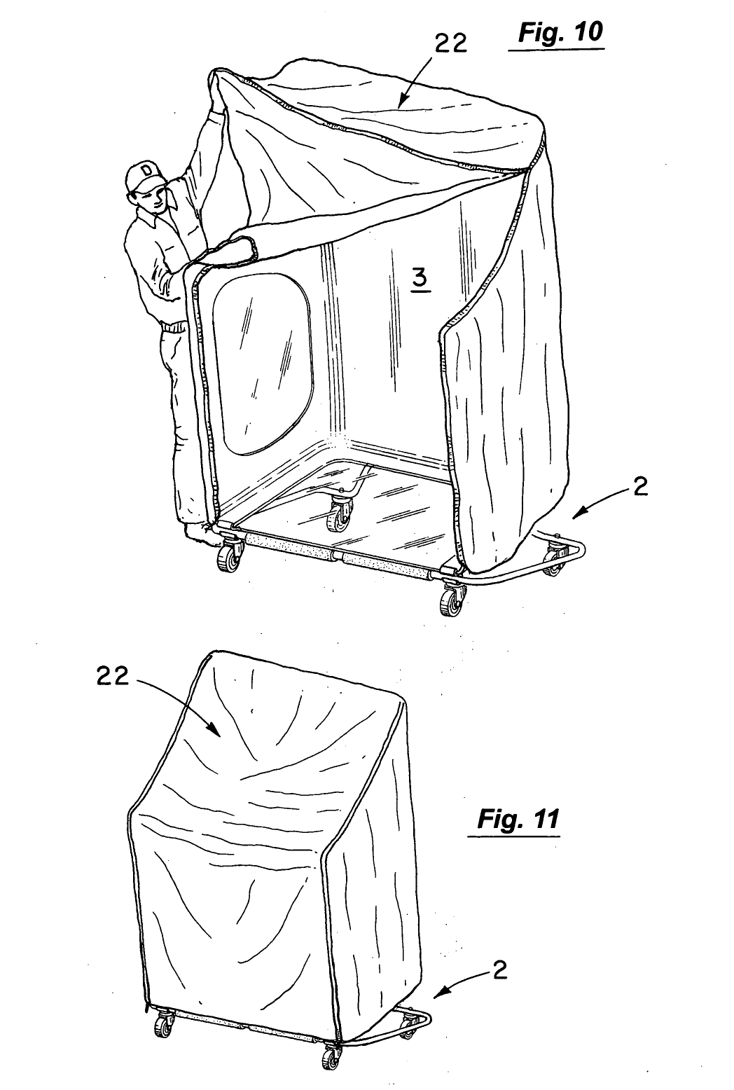

The storage cart 2 has been specially designed so that its bar member 2″ with its pads 12″ (FIG. 5) extends across the lower part of the window 13. The axis 18 of the bar member 2″ in this regard is substantially parallel to the pivotal axis 19 of the window 13. In this manner and with the storage cart 2 secured in place on the rear portion 3″ of the hardtop 3, the padded bar member 2″ will keep the window 13 in its closed position (FIG. 5). More importantly, the padded bar member 2″ will prevent the window 13 from moving away from this closed position as the hardtop 3 and storage cart 2 secured thereto are manipulated as a unit to the upright storage position of FIGS. 7-9. In this storage position of FIGS. 7-9, the window 13 is then safely held in its closed position (FIG. 9) up off the floor 21 and cannot flop or fall down to strike or be dragged across the floor 21. A cover 22 is then preferably provided as in FIGS. 10-11 to enclose and further protect the stored hardtop 3.

To re-attach the stored hardtop 3, these steps are simply reversed. That is, the upright, stored hardtop 3 of FIGS. 7-8 is manipulated to again be atop the vehicle body 5 as in FIG. 5, the storage cart 2 removed, and the members 7 and 9 of FIG. 1 re-attached to secure the hardtop 3 to the vehicle body 5.

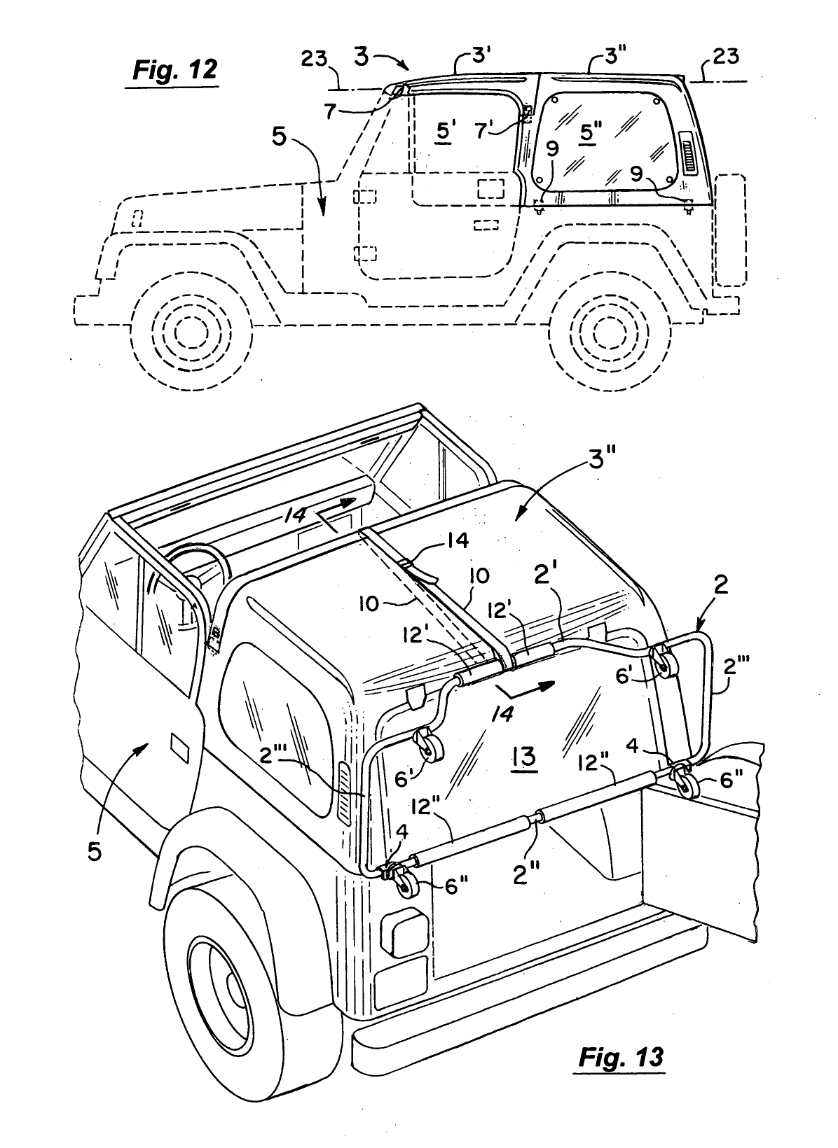

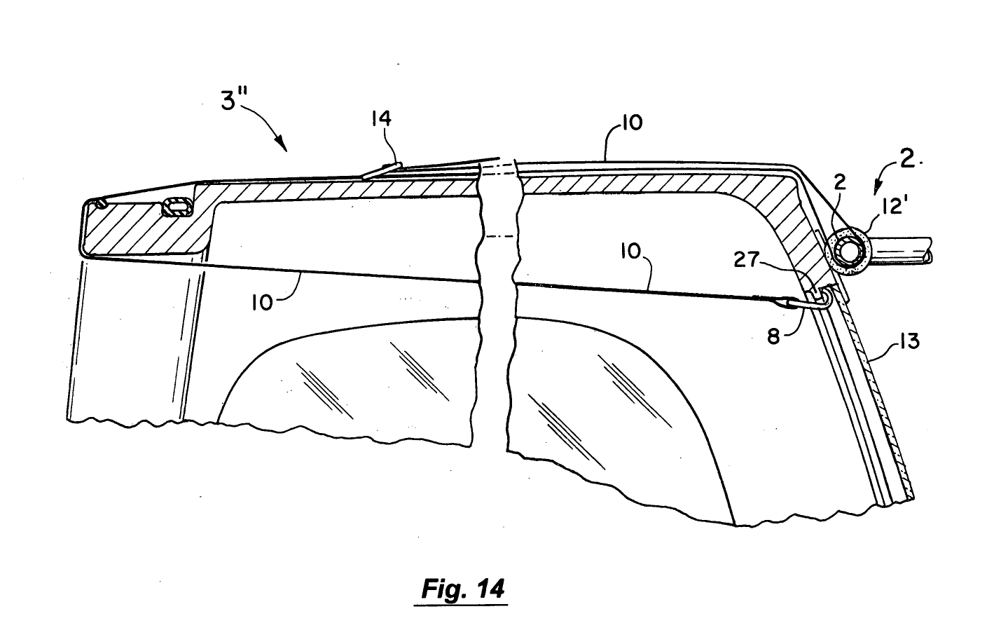

In the embodiment of FIGS. 1-11, the hardtop 3 is shown as being a one-piece top with the front and rear portions 3,3″ integral with one another. However, the removal and storage system of the present invention is equally adaptable to two-piece hardtops such as 3 in FIG. 12. In such two-piece hardtops, the front portion 3′ can be detached from the vehicle body at 7 and from the rear portion 3″ at 7′. With the rear portion 3″ detached at 9 from the vehicle body 5 but still atop the vehicle body 5 as in FIG. 13, the storage cart 2 is again clipped at 4 to the rear portion 3″ as in the one-piece top. However, the clip 8 and flexible strap 10 of FIG. 5 are preferably attached as shown in FIGS. 13 and 14. That is, the clip 8 (see FIG. 14) is hooked to the underneath side of the rear portion 3″ at the location of lip 27 with the flexible strap 10 extending underneath and then atop the rear portion 3″ and around the bar member 2′ back to the buckle 14.

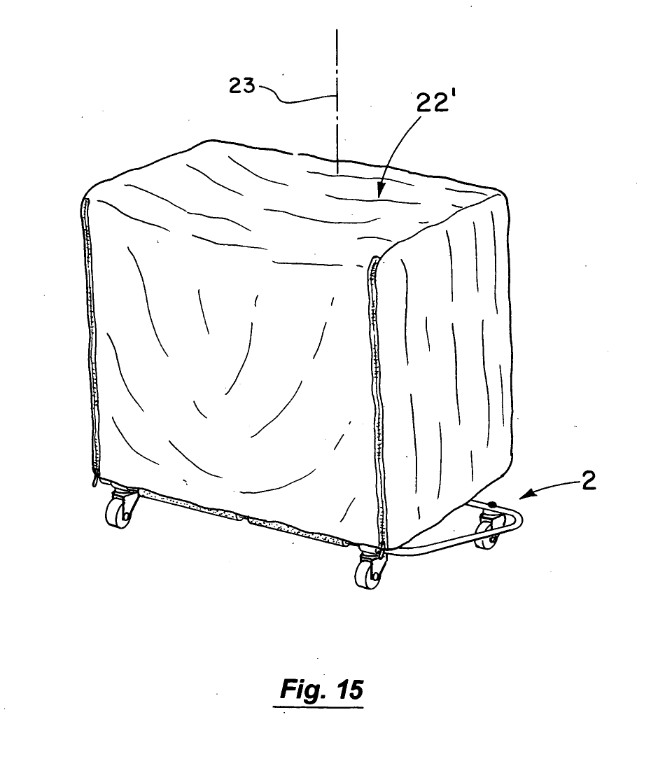

In this manner, the same strap 10 as used for the one-piece top of FIGS. 1-11 can be used with the rear portion 3″ of the two-piece top. If desired, the adjustable length strap 10 could be shortened and/or used in the same basic configuration as in FIG. 5 with the clip 8 hooked to the front edge of the rear portion 3″. However, the configuration of FIGS. 13-14 for a two-piece top is preferred. As with the one-piece top, the rear portion 3″ of the two-piece top of FIG. 13 is preferably stored upright with its axis 23 extending substantially vertically as in FIG. 15 and with a protective cover 22′ provided as also shown in FIG. 15. As with the one-piece top as shown in FIGS. 8-9 and in its stored position, the bar member 2″ of the horizontally extending portion H of the cart 2 (which horizontal portion H includes the cross bars 2′″ as seen FIGS. 4, 8, and 9) still will abut the rear portion 3″ of the hardtop 3 adjacent the clips 4. Additionally, in both the one-piece and two-piece hardtops, the bar 2′ of the vertically extending portion V of the cart 2 also abuts the rear portion 3″ of the hardtop 3 in the manner of FIGS. 8 and 9.

It is noted that the illustrated hardtops in FIGS. 1 and 12 are shown covering the passenger and deck sections 5′, 5″ of the vehicle body 5. However, the invention is equally adaptable to hardtops that cover only part of the passenger section or only cover the deck section 5″. These last hardtops commonly just have a single piece similar to 3″ and the front and rear references in describing the illustrated hardtops 3 above would then be adapted to describe them. The front and rear top portions described above would therefore be the corresponding portions of the abbreviated, single-piece top and the vehicle sections covered by them, for example, would then refer to forward and rearward sections of the deck 5″.

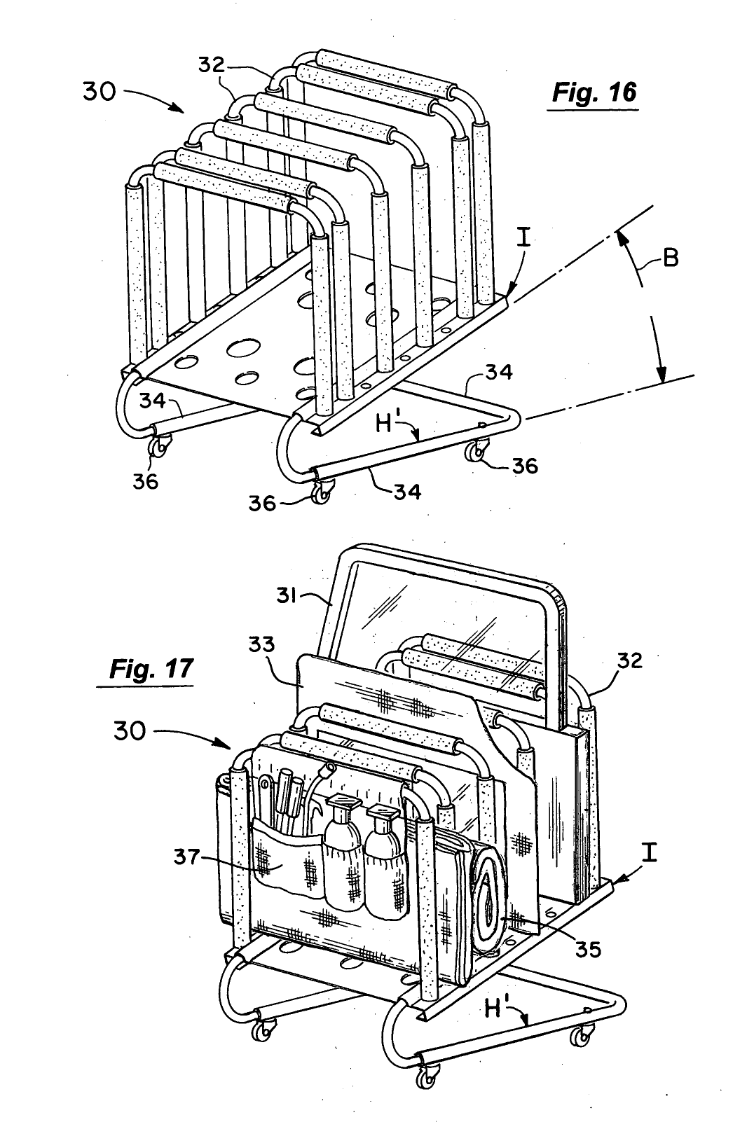

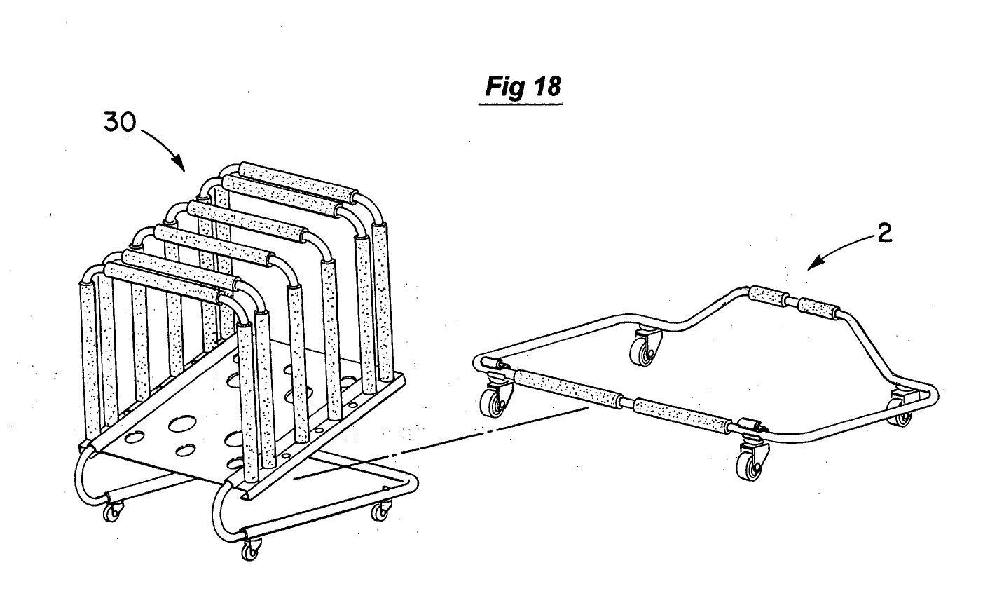

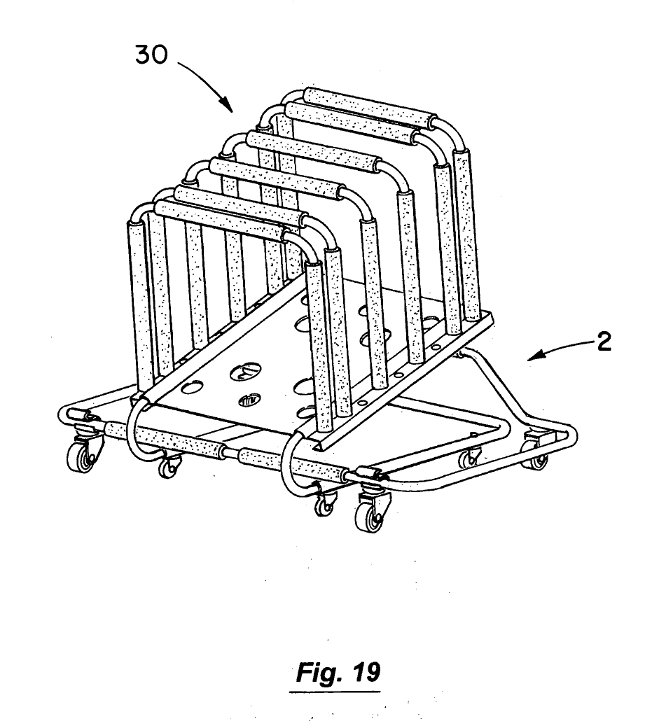

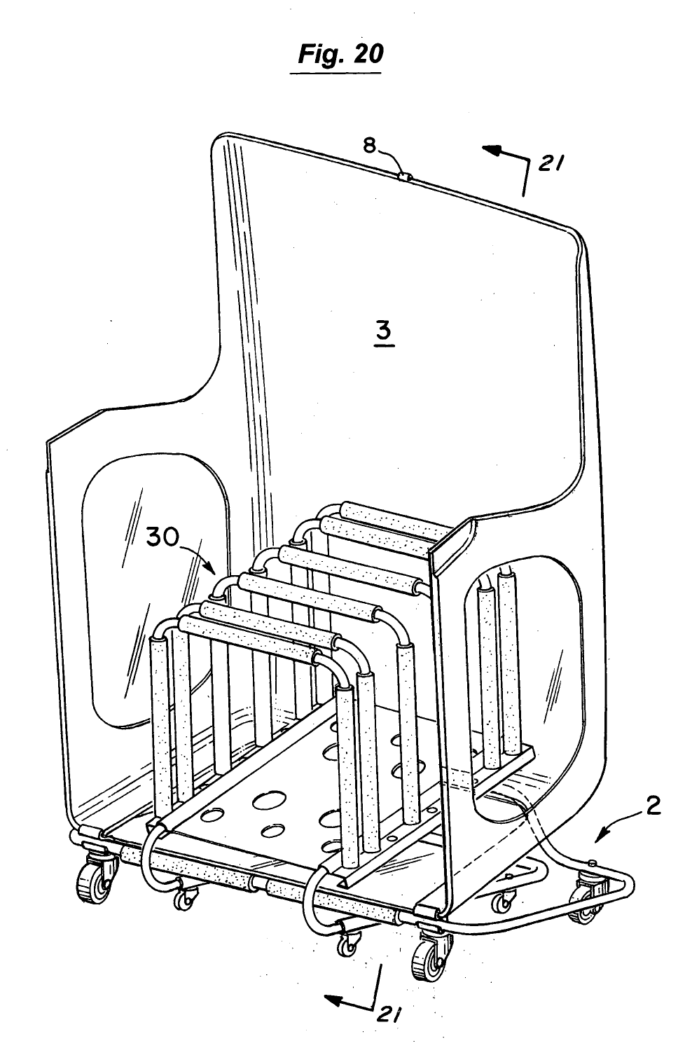

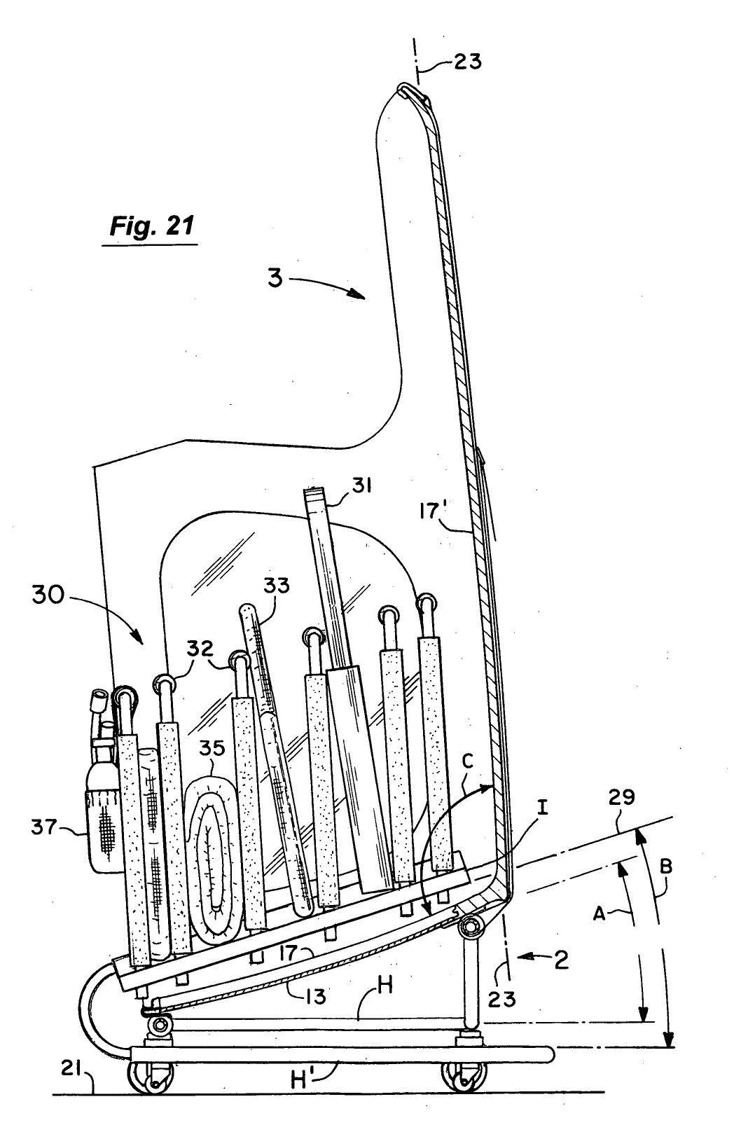

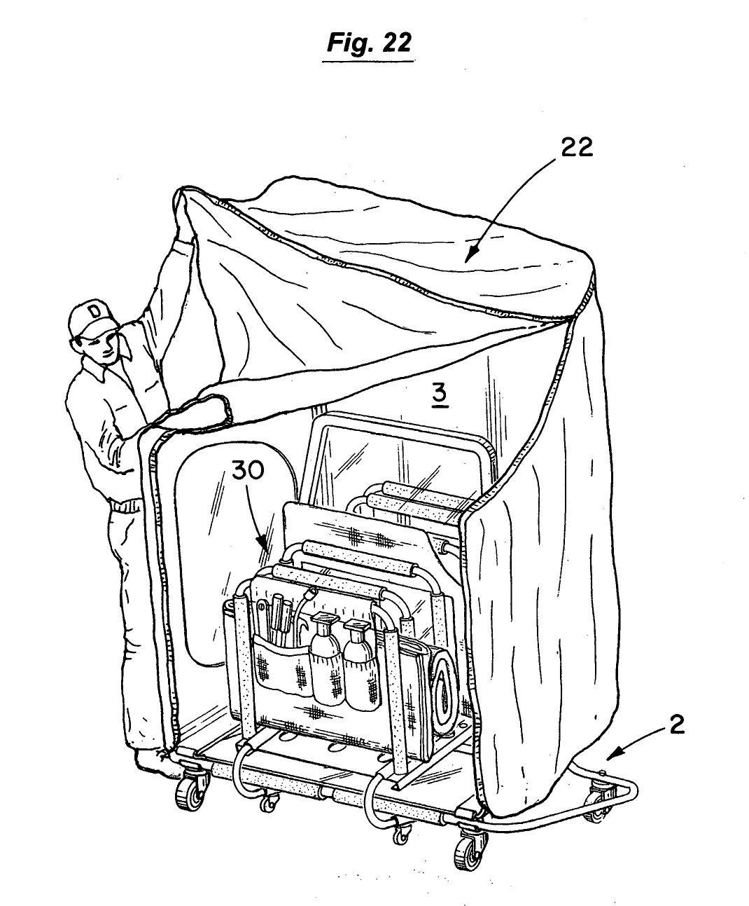

The storage system of the present invention also can include the caddy 30 of FIG. 16 with its vertically extending dividers 32. The caddy 30 as illustrated in FIG. 17 can be used to organize and store various vehicle accessories such as the hard door 31, soft door 33, roll 35, and pocketed tool holder 37. The caddy 30 has a substantially horizontally extending portion H′ (FIG. 16) of bars 34 mounted on rollers 36 and an inclined portion I. The inclined portion I extends at an acute angle B (FIG. 16) to the horizontally extending portion H′. The caddy 30 and cart 2 (FIG. 18) are designed to mate or nest with one another as shown in FIG. 19. More importantly, the caddy 30 is designed to mate with the cart 2 with the hardtop 3 secured and supported on the cart 2 (FIG. 20). Further, the caddy 30 and cart 2 will mate with both of them loaded with the respective hardtop 3 and vehicle accessories 31, 33, 35, and 37 (FIG. 21). In the mated position of FIG. 21, the loaded caddy 30 and cart 2 form a very neat and compact shape and as in FIGS. 10-11 can be enclosed by a protective cover 22 (FIG. 22). The compact arrangement of FIG. 22 is such that the same protective cover as in FIGS. 10-11 can be used if desired.

The compact mating of the loaded caddy 30 and cart 2 as in FIG. 21 is facilitated by having the acute angle B of the caddy portions H′ and I greater than the acute angle A between the horizontal cart portion H and the windowed rear section 17 of the hardtop 3. More specifically, hardtops such as 3 in FIG. 21 commonly have an overall frame with a first substantially planar section 17′ extending along a first axis 23 and a second substantially planar section 17 extending along a second axis 29. The axes 23 and 29 intersect at an angle C (FIG. 21) which is typically an obtuse angle. In the stored position of FIG. 21, the planar section 17 with the window 13 then forms the acute angle A with the horizontally extending cart portion H. The result of the mating or nesting angles A and B is then the compact shape of FIG. 21. Although described and shown in FIGS. 20-22 with a one-piece hardtop 3, the caddy 30 and cart 2 can also accommodate just the rear portion 3″ of a two-piece hardtop as in FIGS. 12-15 or a hardtop that was essentially just a single, rear piece covering the deck of the vehicle.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. A method of removing and storing a vehicle hardtop, said hardtop having front and rear portions removably attached to the body of a vehicle in respective first positions covering respective forward and rearward sections of the vehicle body, the front and rear portions of the hardtop in said first positions being adjacent one another and extending along an axis aligned substantially horizontally, said method including the steps of:
(a) detaching at least the rear portion of the hardtop from the vehicle body with said rear portion remaining substantially in said first position covering the rearward section of the vehicle body,
(b) securing a storage cart to the rear portion of said hardtop with said rear portion still remaining substantially in said first position covering the rearward section of the vehicle body,
(c) removing at least said rear portion of the hardtop with said storage cart secured thereto from the vehicle body, and
(d) placing the storage cart secured to said rear portion of the hardtop on a substantially horizontal surface with the axis of said rear portion of the hardtop extending substantially vertically.

2. The method of claim 1 wherein said storage cart in step (b) is secured in a fixed position to the rear portion of the hardtop.

3. The method of claim 2 wherein said fixed position of step (b) is rearwardly of the rear portion of the hardtop along said substantially horizontal axis.

4. The method of claim 2 wherein step (b) includes the further limitation of securing said storage cart to the rear portion of the hardtop and separately securing said storage cart to the front portion of the hardtop.

5. The method of claim 4 including the further limitation of securing said storage cart to the rear portion of the hardtop with at least one clip and securing the storage cart to the front portion of the hardtop with at least one clip and at least one flexible strap.

6. The method of claim 1 wherein step (b) includes the further limitation of securing said storage cart to the rear portion of the hardtop by drawing a flexible strap taut.

7. The method of claim 1 wherein said front and rear portions of the hardtop are separate pieces removably attachable to each other and said rear portion and storage cart in step (c) are removed as a unit from the vehicle body.

8. The method of claim 7 wherein step (b) includes the further limitation of securing said storage cart to the rear portion of the hardtop with at least one clip and a flexible strap.

9. The method of claim 1 wherein said rear portion of the hardtop has a frame and a window mounted to the frame for pivotal movement about an axis relative to said frame between closed and open positions and said method further includes the step of providing said storage cart with a member extending in step (b) across said window in said closed position to prevent said window from moving away from said closed position in steps (c) and (d).

10. The method of claim 9 wherein said axis of said window is substantially horizontal in step (b) and said member of said storage cart extends substantially horizontally in step (b).

11. The method of claim 1 including the further limitation of providing rollers on said storage cart and rolling said storage cart with the rear portion of the hardtop secured thereto across said substantially horizontal surface in step (d).

12. The method of claim 1 including the further limitation of reversing the order of steps (a)-(d) to re-attach at least the rear portion of the hardtop to the vehicle body in said first position covering the rearward section of the vehicle body.

13. The method of claim 1 wherein said front and rear portions of the hardtop are integral with each other forming a one-piece hardtop and said method includes the further limitation of reversing the order of steps (a)-(d) to re-attach the front and rear portions of the hardtop to the vehicle body in said first positions covering the forward and rearward sections of the vehicle body.

14. The method of claim 1 including the further step of covering at least said rear portion of said hardtop in the position of step (d) with a protective cover.

15. The method of claim 1 wherein said front and rear portions of the hardtop are integral with each other forming a one-piece hardtop and said method includes the further step of covering the front and rear portions of said hardtop in the position of step (d) with a protective cover.

16. A storage cart for a vehicle hardtop, said hardtop having front and rear portions removably attached to the body of a vehicle in respective first positions covering respective forward and rearward sections of the vehicle body, the front and rear portions of the hardtop in said first positions being adjacent one another and extending respectively along an axis aligned substantially horizontally, the storage cart including:
first members for securing the storage cart to the rear portion of the hardtop with the hardtop detached from the vehicle and said rear portion substantially in said first position covering the rearward section of the vehicle body and
second members for supporting the storage cart secured to the rear portion of the hardtop on a substantially horizontal surface with the axis of said rear portion of the hardtop extending substantially vertically.

17. The storage cart of claim 16 wherein said storage cart is secured in a fixed position to the rear portion by said first members with at least the rear portion of the hardtop detached from the vehicle and said rear portion substantially in said first position covering the rearward section of the vehicle body.

18. The storage cart of claim 17 wherein said front and rear portions of the hardtop are integral with each other forming a one-piece hardtop and said first members securing said storage in said fixed position to said rear portion include at least one clip attached to the rear portion and at least another clip attached to said front portion.

19. The storage cart of claim 18 wherein said first members securing said storage cart to said hardtop further include a flexible strap connected between said another clip attached to said front portion of said hardtop and said storage cart.

20. The storage cart of claim 19 wherein said flexible strap has an adjustable length between said another clip attached to said front portion of the hardtop and said storage cart.

21. The storage cart of claim 17 wherein said first members include at least one clip attached to said rear portion of the hardtop at a first location and at least another clip attached to said rear portion at another location.

22. The storage cart of claim 21 wherein said first members securing said storage cart to said hardtop further include a flexible strap connected between said another clip attached to said rear portion of said hardtop and said storage cart.

23. The storage cart of claim 22 wherein said flexible strap has an adjustable length between said another clip attached to said rear portion of the hardtop and said storage cart

24. The storage cart of claim 21 wherein said front and rear portions of said hardtop are separate pieces removably attachable to each other.

25. The storage cart of claim 16 wherein said rear portion of the hardtop has a frame and a window mounted to the frame for pivotal movement about an axis relative to said frame between closed and open positions and said storage cart secured to said rear portion has a member extending across said window in said closed position to prevent said window from moving away from said closed position with said storage care secured to said rear portion of the hardtop.

26. The storage cart of claim 25 wherein said member extends along an axis substantially parallel to the axis of said window.

27. The storage cart of claim 16 wherein said second members are rollers.

28. The storage cart of claim 16 further including a protective cover over at least the rear portion of the hardtop with the axis of the rear portion extending substantially vertically.

29. The storage cart of claim 16 wherein said front and rear portions are integral with each other forming a one-piece hardtop and said storage cart further includes a protective cover over said front and rear portions of the hardtop with the axis of the front and rear portions extending substantially vertically

30. The storage cart of claim 16 wherein said storage cart with the rear portion of the hardtop secured thereto and the axis of the rear portion extending substantially vertically has a substantially horizontally extending cart portion abutting the rear portion of the hardtop and a substantially vertically extending cart portion abutting the rear portion of the hardtop.

31. A mating storage arrangement for a vehicle hardtop and other vehicle accessories, said storage arrangement including a cart for storing at least a rear portion of the vehicle hardtop and a mating caddy for storing other vehicle accessories, said caddy mating with said cart with the rear portion of the vehicle hardtop stored thereon, said rear portion of the vehicle hardtop having a frame with a first substantially planar section extending along a first axis and a second substantially planar section extending along a second axis at angle to the first axis,
said cart having a substantially horizontally extending cart portion supporting the rear portion of the vehicle hardtop thereon with the first axis of the first section of the rear portion extending substantially vertically and with the horizontally extending cart portion substantially beneath the second section of the rear portion of the vehicle hardtop, said second section of the rear portion of the vehicle hardtop supported on said cart forming an acute angle A with the substantially horizontally extending cart portion, and
said caddy having a substantially horizontally extending caddy portion and an inclined caddy portion extending therefrom at an acute angle B greater than said acute angle A wherein said horizontally extending cart portion and said second section of the rear portion of the hardtop supported thereon are received between the horizontally extending caddy portion and the inclined caddy portion with said cart and caddy in a mating position.

32. The storage arrangement of claim 31 wherein said cart has first members for securing the rear portion of the vehicle hardtop thereto in a fixed position.

33. The storage arrangement of claim 31 wherein said caddy further includes dividers extending substantially vertically from the inclined caddy portion to receive said other vehicle accessories.

34. The storage arrangement of claim 31 wherein the second section of the said rear portion of said vehicle hardtop has a window therein.

35. The storage arrangement of claim 31 wherein the angle between the first and second sections of the rear portion of the vehicle hardtop is an obtuse angle.

36. The storage arrangement of claim 31 further including a protective cover over said cart and caddy in said mating position.

37. The storage arrangement of claim 31 wherein said horizontally extending cart portion and said horizontally extending caddy portion have rollers for movement across a substantially horizontal surface.
